(19) United States
(12) Patent Application Publication
(10) Pub. No.: US 2015/0304329 A1
(43) Pub. Date: Oct. 22, 2015

(54) Method and apparatus for managing access rights

(71) Applicant: NOKIA TECHNOLOGIES OY, Espoo (FI)

(72) Inventors: Zheng Yan, Espoo (FI); Jussi Jaatinen, Helsinki (FI)

(21) Appl. No.: 14/437,873

(22) PCT Filed: Oct. 23, 2012
(86) PCT No.: PCT/FI2012/051014

§ 371 Date: Apr. 23, 2015

(51) Int. Cl. H04L 29/06; G06F 21/62

(52) U.S. Cl. CPC H04L 63/10; G06F 21/6218

(57) ABSTRACT

In accordance with an example embodiment of the present invention, there is provided an apparatus, configured to compare reputation information of a first user to access criteria relating to data of a second user, and to decide on an extent of access to the data based at least in part on the comparison, and a transmitter configured to cause an indication of the decision to be transmitted. The apparatus may receive the reputation information from a reputation source.

### TECHNICAL FIELD

The present application relates generally to managing data and access rights to data.

### BACKGROUND

Users need to store their data, which may comprise confidential information such as at least one of financial, healthcare and legal documents, in secured ways. Users may store documents in filing cabinets, safes, bank vaults, archives or company premises in paper or electronic format, for example. Different storage methods provide different usability and security features. For example, a document stored in a bank vault is reliably stored in the sense that it is very unlikely to be stolen, but accessing it requires visiting the bank to enter the vault in person. As another example, a document stored in a public internet site is immediately accessible by anyone, rendering its contents public. As a yet further example, a document stored in a corporate data server may be accessible by persons who have been authorized to access data systems of the corporation. Such a data system may include processes followed by data owners and subscribed system users, and a data storage.

Choosing a storage method may involve assessing which persons can be trusted and thus allowed to access information stored in the storage. For example, corporate IT staff may undergo background checks to verify they can be trusted to maintain servers containing confidential information. A cloud storage service provider may assess the risks involved in allowing another party, such as for example another service provider or company, to access data, which may involve assessing whether the party is trustworthy enough and what kind of risks are involved.

In general electronically stored information at a third party may be conveniently accessible when needed, but controlling access to it may cause challenges with regard to security, privacy and trust, compared to controlling access to paper documents.

Cloud-based storage services offer benefits including dependability, which may be derived from redundancy in storage, and accessibility which may be derived from establishing the cloud-based system based on a public network, such as for example the Internet. Security may be provided by data encryption and/or authentication of users seeking access to the cloud-based storage system. Secure tunnels may be configured over public networks to prevent unauthorized parties from intercepting communication between a cloud-based storage system and an authorized user accessing the system over the public network.

### SUMMARY

Various aspects of examples of the invention are set out in the claims.

According to a first aspect of the present invention, there is provided an apparatus, comprising at least one processing core configured to compare reputation information of a first user to access criteria relating to data of a second user, the at least one processing core being configured to decide on an extent of access to the data based at least in part on the comparison, and a transmitter configured to cause an indication of the decision to be transmitted.

According to a second aspect of the present invention, there is provided a method, comprising comparing reputation information of a first user to access criteria relating to data of a second user, deciding on an extent of access to the data based at least in part on the comparison, and transmitting an indication of the decision.

According to a third aspect of the present invention, there is provided an apparatus, comprising at least one processor, at least one memory including computer program code, the at least one memory and the computer program code configured to, with the at least one processor, cause the apparatus to at least receive from a reputation center an indication that a first user is to be given access to data of a second user, the data being stored in the apparatus, and provide the data to the first user.

According to a fourth aspect of the present invention, there is provided a method, comprising receiving from a reputation center an indication that a first user is to be given access to data of a second user, the data being stored in an apparatus, and providing the data to the first user.

Further aspects of the present invention comprise, for example, computer programs configured to cause methods according to the second and fourth aspects to be performed.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a system capable of supporting at least some embodiments of the invention;

FIG. 2 illustrates a block diagram of an apparatus such as, for example, a reputation center or a storage system, in accordance with at least one example embodiment of the invention;

FIG. 3 is a signaling diagram illustrating signaling according to at least some example embodiments of the invention;

FIG. 4 is a flowchart illustrating a first method in accordance with at least some embodiments of the invention; and

FIG. 5 is a flowchart illustrating a second method in accordance with at least some embodiments of the invention

### DETAILED DESCRIPTION OF THE DRAWINGS

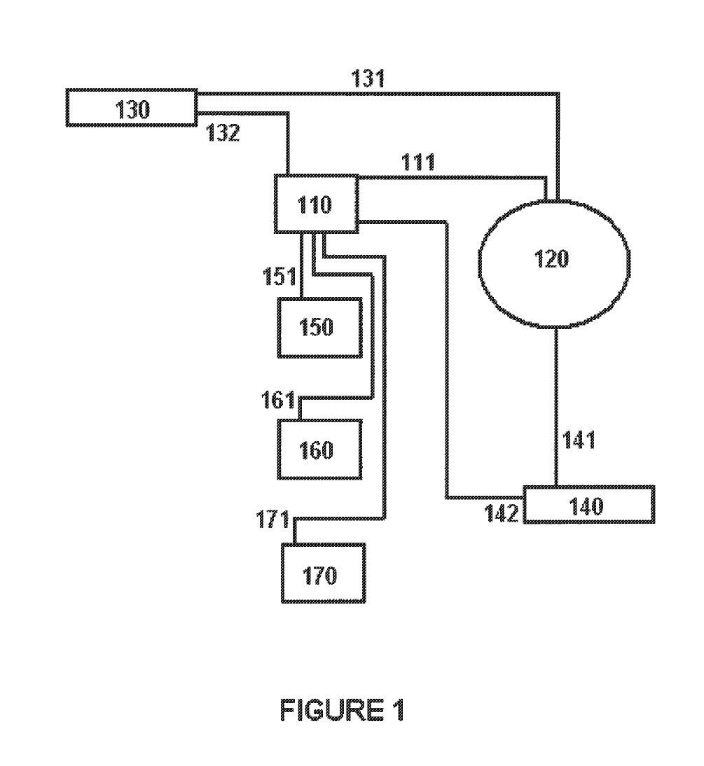

An example embodiment of the present invention and its potential advantages are understood by referring to FIGS. 1 through 5 of the drawings.

FIG. 1 illustrates an example of a system capable of supporting at least some embodiments of the invention. In FIG. 1 is illustrated a storage service system, such as for example a cloud storage system, 120. In the following this element will be referred to as storage system. User 140 represents a user, or his device, that is configured to access and interact with storage system 120. The connection between user 140 and storage system 120 is illustrated as connection 141. Connection 141 may take the form of a wire-line interface, such as for example a connection over a network of nodes, which are not illustrated. Connection 141 may comprise a secure tunnel over the network of nodes. In some embodiments, at least part of connection 141 comprises a radio interface, such as where user 140 comprises a wireless user equipment configured to access a network via a radio air interface, such as for example a cellular air interface. User 140 may update or store data in storage system 120 over connection 141, or data of user 140 may be stored in storage system 120 by other means. Reputation center 110 is configured to interface with storage system 120 via connection 111, which may be wire-line or at least in part wireless as discussed above in connection with connection 141. Alternatively, reputation center 110 may be comprised in storage system 120. User 130 may be configured to interface with storage system 120 via connection 131. Connection 131 may be wire-line or at least in part wireless as discussed above in connection with connection 141. User 130 may have data stored in storage system 120, or user 130 may be interested in obtaining from storage system 120 data of other users. User 140 may be enabled to interface with reputation center 110 via connection 142, which like connection 141 may be at least in part wireless, completely wireless or entirely wire-line.

In some embodiments, user 130 has an interface to reputation center 110, this interface is illustrated in FIG. 1 as connection 132. In some embodiments, user 140 has an interface to reputation center 110, this interface is illustrated in FIG. 1 as connection 142. At least one of connection 142 and connection 132 may be wire-line or at least in part wireless as discussed above in connection with connection 141. In embodiments where at least one of connection 132 and connection 142 is absent, the users may interact with reputation center 110 indirectly via storage system 120.

Reputation center 110 may interface to reputation source 150 via connection 151 to retrieve or collect reputation information concerning a user. Reputation center may interface to further reputation source 160 via connection 161. Reputation center may interface to further reputation source 170 via connection 171. In some embodiments, at least one reputation source is comprised in reputation center 110. In some embodiments, where reputation center 110 is comprised in storage system 120, at least one reputation source may also be comprised in storage system 120.

User 140 desiring to store or have stored his data in storage system 120 may define data access criteria by specifying which users are allowed to access the data, or by describing characteristics, situations or conditions relating to users who are allowed to access the data. User 140 may be configured to provide the access criteria to storage system 120 via connection 141. In some embodiments, the data of user 140 is stored into storage system 120 by user 140, or an employer, bank or healthcare provider of user 140, for example, and user 140 separately sets or modifies access criteria relating to the data over connection 141. In some embodiments, user 140 provides the access criteria to reputation center 110, via connection 142, or by causing storage system 120 to provide the access criteria to reputation center via connection 111 interconnecting storage system 120 and reputation center 110.

In some embodiments, user 140 defines, or causes to be defined, in the access criteria what kind of users should be given access to the data. This user 140 may define access rights to be provided to a set of users that is not explicitly identified in the access criteria in the sense that identities of users or user groups would be included in the access criteria, but characteristics or conditions of which are described in the access criteria. In some cases, the access criteria may describe at least one situation, such that a user in that situation is to be given access. The characteristics may comprise reputation, such that user 140 issues access rights to be given to the data only to users satisfying at least one criterion relating to reputation. The at least one criterion relating to reputation may comprise a threshold value of reputation defining a limit in reputation that separates users not to be given access from users that should be given access. For example, if reputation is expressed using a metric that extends in from zero to one, user 140 may define that only users with reputation exceeding 0.9 are to be given access. The at least one criterion relating to reputation may comprise an identity of at least one reputation class. For example, where users are classified into two classes, good reputation and bad reputation, user 140 may define in the access criteria that only users with good reputation are to be given access. As another example, where users are classified into three classes, good reputation, intermediate reputation and bad reputation, user 140 may define in the access criteria that only users with intermediate or good reputation are to be given access to the data.

Where reputation may be derived from more than one source, the at least one criterion relating to reputation may define a threshold level or class of reputation in combination with at least one reputation source. In such embodiments, user 140 may define in access criteria that, for example, a reputation defined as at least 90% positive feedback from a certain, identified reputation source is needed for access to the data. In some embodiments, the access criteria may define more than one reputation source with separate criteria for each reputation source, wherein a user seeking access to the data must fulfill all criteria to be given access. In some embodiments, the access criteria define a specific reputation source and corresponding threshold level or class, and also that in case the defined reputation source is unavailable, an auxiliary reputation source, also identified in the access criteria, is to be used. Threshold level or class information may also be provided, in the access criteria, concerning the auxiliary reputation source. Access criteria may also define a requested penalty for abuse.

Defining access criteria that comprise reputation aspects may allow user 140 to specify that only trustworthy persons can access his data. A reputation provided by a reliable reputation source can be utilized to prevent malicious access to the data of user 140. A reputation source may comprise a public reputation source. User 140's data may be strored in storage system 120 in an encrypted form to prevent operators of storage system 120 from accessing the data. Responsive to access being granted to a requesting user, the data may be re-encrypted for the requesting user, for example using a public key of the requesting user. Re-encrypting may comprise transforming the original encryption of a symmetric key used for data encryption by performing a new encryption operation in order to make the encrypted symmetric key accesible by the authorized requesting user, subsequent to which it becomes possible for the requesting user to access the plain data.

User 130 may issue a request for data of user 140. User 130 may issue the request via connection 131 to storage system 120, responsive to which storage system 120 may be configured to request reputation center 110 to assess whether user 130 satisfies access criteria relating to the data. Storage system 120 may be configured to request reputation center 110 to do this via connection 111, for example. The request sent from storage system 120 to reputation center 110 may comprise an identity of requesting user 130 and an identifier of the data, and the access criteria if they are stored in storage system 120. Alternatively, user 130 may transmit the request via connection 132 to reputation center 110, which may store or have access, via connection 111 from storage system 120, to the access criteria relating to the requested data.

Responsive to being in possession of the access criteria relating to the requested data and an identity of the requesting user, reputation center 110 may be configured to assess whether the requesting user, in this example user 130, satisfies the access criteria. Assessing may comprise obtaining reputation information of the requesting user and comparing it to the access criteria. Obtaining reputation information may comprise requesting the reputation information from a reputation source, for example where the access criteria define that a user requesting access to the data must have a positive feedback rate exceeding 80% from reputation source 150, reputation center 110 may be configured to request a feedback rate from reputation source 150, using the identity of the requesting user, via connection 151. Alternatively where the access criteria don't define a reputation source, reputation center 110 may be configured to use a default reputation source. Where the access criteria don't define a threshold level or class, reputation center 110 may be configured to use a default one. For example, where the access criteria defines only that a requesting user must have a good reputation without specifying a threshold level or class, or reputation source, reputation center 110 may be configured to select a default reputation source, and apply a default threshold level or class. Examples of default reputation sources may include parties with interaction experiences with requesting user 130, the customers of requesting user 130 who may provide feedback on user 130, a performance monitor of requesting user 130, authorized parties, such as for example online auction sites, banks, police records and credit histories. An example of a threshold level for an online auction site derived reputation is 95% positive feedback from customers or interaction partners. An example of a threshold class for reputation derived from a bank is that the requesting individual has no recent history of default. An example of a threshold class for reputation derived from police records is that the requesting individual has no recent convictions for crimes. An example of a threshold class for reputation derived from a credit history is that the requesting individual has a history of managing his loans successfully.

In some embodiments, reputation is generated based on at least one of reputation contributed by user feedback, reputation contributed by performance monitoring and/or reporting, and reputation contributed by authorized parties. Reputation contributed by user feedback may be based at least in part on voting results, votes being cast by interaction partners. In some embodiments, effects of votes are weighted by reputations of voting interaction partners. In some embodiments, effects of votes are decremented as time progresses, resulting in a larger weight being assigned to more recent votes. Reputation contributed by performance monitoring and/or reporting may be based at least in part on records of reliability, availability and/or a level of performance. Effects of such records may be decremented as time progresses, resulting in a larger weight being assigned to more recent records. The number of votes and performance monitoring reports may also be considered in reputation generation. The bigger the number of them, the more convincing the generated reputation.

When the comparison indicates the requesting user is to be denied access to the data, reputation center 110 may be configured to indicate this to the entity that transmitted the request to reputation center 110. Where reputation center 110 received the request from user 130, it may be configured to indicate to user 130 that access was denied, optionally also indicating the reason for denial. The reason for denial may comprise an identity of a reputation source or sources used in performing the assessment. Where reputation center 110 received the request from storage system 120, it may be configured to indicate to storage system 120 that access is denied, optionally also indicating the reason for denial.

When the comparison indicates the requesting user to be granted access to the data, reputation center 110 may be configured to indicate this to at least one of the requesting user and storage system 120. The indication may comprise an expression of extent of access, where access is granted to only part of the data. Access may be only partially granted if, for example, the access criteria comprise plural thresholds defining varying levels of reputation needed to access the data to varying extent. For example, the highest threshold in reputation may be required to be exceeded in order to be granted full access. Partial access may comprise that access is granted to a subset of the data or that a resolution of the data is decreased. Decreasing resolution may comprise that when the data is provided to the requesting user, an image or video file is re-sampled at lower resolution. Storage system 120 may alternatively store a higher-resolution and a lower-resolution version of the data.

When reputation center 110 indicates that access is to be granted, storage system 120 may responsively perform re-encryption and inform the requesting user that the data is available. The requesting user may then request the data to be transmitted, for example via connection 131, from storage system 120 to the requesting user. Re-encrypting may comprise that storage system 120 obtains a key related to the requesting user from reputation center 110 and re-encrypting the data encryption key for the requesting user using the key related to the requesting user. Alternatively, the reputation center 110 may provide a key relating to the requesting user to storage system 120 for use in re-encrypting the data for the requesting user. In some embodiments, the requesting user is queried by reputation center 110 for a public key after it has been determined, that the requesting user is to be granted at least some access to the data. An advantage of querying for the key only after it has been determined that access is to be granted is that unnecessary signaling of keys is avoided in cases where access to the data is denied.

In some embodiments, storage system 120 is not fully trusted by the data owner. Thus, the personal data saved in storage system 120 may be encrypted by the data owner. Other entities may be enabled to access the personal data in order to fulfill a service for the data owner or other parties. How to control personal data access at a semi-trusted or distrusted data center and how to greatly reduce the potential risks caused by distrustworthy access are practical issues.

In some embodiments, encryption of the stored data isn't used. In these embodiments the data is stored in non-encrypted form, and a copy of the non-encrypted data is provided responsive to the the comparison indicating that the requesting user fulfills the access criteria and is to be granted access the information.

In some embodiments, reputation center 110 or storage system 120 is configured to inform the requesting user of a penalty associated with abusing access to the requested data. Optionally, the requesting user is prompted to accept or reject the offered penalty before finalizing the granting of access to the data. The penalty may be informed in connection with the indication that access is to be granted. The penalty may be a default penalty of reputation center 110, or alternatively it may be derived from the access criteria relating to the requested data. For example, the access criteria may specify that access is only to be granted to users with more than 80% positive feedback from a specific peer-to-peer site, that the feedback must comprise more than 300 entries, and that a penalty for disclosing the requested data to third parties is that the reputation score of the requesting user in the peer-to-peer site is wiped out. Where the requesting user is prompted to accept the offered penalty, reputation center 110 may be configured to only finally indicate that access is to be granted responsive to the requesting user accepting the offered penalty.

In some embodiments, storage system 120 is configured to pay a fee, such as for example an annual fee, to reputation center 110 in exchange for the services of reputation center 110. In some embodiments, user 140 comprises another storage system 120, such as for example a cloud storage system. Services of reputation center 110 may comprise, for example, at least one of re-encryption of credential generation, reputation information handling and deciding on granting access to data.

In some embodiments, the penalty depends on the reputation of the requesting user, wherein a user with a higher reputation will suffer a lower penalty.

Alternatively, a requesting user with a lower reputation, which is still enough to be given access, may suffer a higher penalty for misuse or disclosure of the information. In some embodiments, the penalty may escalate in that a user abusing trust for a second time suffers an increased penalty.

A default penalty specified by reputation center 110 may comprise that the reputation information of the requesting user in the reputation source used is decremented to reduce the reputation of the requesting user in the reputation source used. In other words, the penalty may comprise that the reputation of the requesting user is made worse. For example, where an interaction-based reputation comprises 100 positive votes and five negative votes, the penalty may comprise adding 50 negative votes.

In embodiments where a penalty is attached to abusively disclosing the requested data to third parties, processing in storage system 120 may comprise that the data is furnished with a digital watermark to help identify the party who discloses the data to third parties. Applying the digital watermark may comprise that the requested data is subtly modified in a way specific to the requesting user, wherein the requesting user is optionally not informed of the modification. For example, where the requested data comprises a digital X-ray image, the modification may comprise subtle changes to the image file that do not affect the usability and/or quality of the image for legitimate purposes. The modification specific to the requesting user may comprise, for example, that an identity of the requesting user is encoded in the requested data, or a timestamp is encoded in the requested data, such that storage system 120 keeps a record of which users were given copies of the data at which times. The data may also be furnished with a signature from user 140 to prevent modification of the data, for example removal of the digital watermark. The signature may comprise, for example, a hash or cryptographic hash applied to the requested data after addition of the digital watermark. To determine which user has disclosed a copy of the data, an unmodified copy of the data may be compared to the disclosed copy, the difference between the copies corresponding to the modification specific to the user that has disclosed the data. Without access to the unmodified copy, it would be difficult for the requesting user to determine what the modification is. In some embodiments, digital watermarking is only done where storage system 120 is enabled to access an unencrypted version of the stored data. In some embodiments, storage system 120 is not enabled to access an unencrypted version of the stored data. In embodiments where storage system 120 is not enabled to access an unencrypted version of the stored data, storage system 120 may be configured to process the requested data by requesting an encrypted digital fingerprint from the data owner, and aggregating the encrypted digital fingerprint and encrypted requested data together before providing the aggregated data to the requesting user. An encrypted digital fingerprint may be signed by the data owner to achieve non- repudiation.

In general there is provided an apparatus, such as for example a server performing the role of reputation center 110. The apparatus may comprise at least one processing core configured to compare reputation information of a first user to access criteria relating to data of a second user, the at least one processing core being configured to decide on an extent of access to the data based at least in part on the comparison. The access criteria may be received in the apparatus from the second user or from a storage system, for example. The reputation information of the first user may be received in the apparatus from at least one reputation source, which may be identified in the access criteria. The comparing may be configured to occur responsive to a request, optionally identifying the first user, received in the apparatus, to access the data. In some embodiments, the request received from the first user comprises an identity of a reputation source capable of providing reputation information of the first user.

The apparatus may further comprise a transmitter configured to cause an indication of the decision to be transmitted, for example to at least one of the first user and a storage system.

In some embodiments, the indication comprises an indication as to an extent of access. An extent of access may be full access or partial access, for example. In some embodiments, the indication comprises cryptographic information to enable the first user to access, at least in part, the data. The cryptographic information may comprise, for example, an identity of a key used to encrypt the data for the first user or a hash value the first user may use to verify that the data the first user received is authentic.

In some embodiments, the indication comprises an instruction to encrypt the data for the first user. Such an instruction may comprise at least one of a public key of the first user, an identity of the first user, a credential related to the first user or an identity of a key of the first user. Responsive to the instruction, a storage system may be configured to obtain a key of the first user and encrypt the data or a key for the first user. The storage system may obtain the key of the first user from the indication, or from a server storing public keys using an identity of the first user.

In some embodiments, the apparatus is configured to obtain the reputation information of the first user at least in part from the storage service system. Reputation information from the storage service system may comprise information on whether the first user has used the storage service system correctly. In some embodiments, the apparatus is configured to obtain the reputation information of the first user at least in part from a multi-user service. A multi-user service may comprise, for example, at least one of an online auction site, an online peer-to-peer community and a multi-user web of trust service. Reputation information obtained from a multi-user service may comprise reputation information based on feedback concerning the first user from other users of the multi-user service.

In some embodiments, the apparatus is configured to obtain the reputation information of the first user at least in part from at least one of an insurance company, a bank, a police database, a governmental database and a no-fly list. A no-fly list may comprise a list of individuals, maintained by a government agency or an airline, wherein the individuals on the list are forbidden from boarding aircraft.

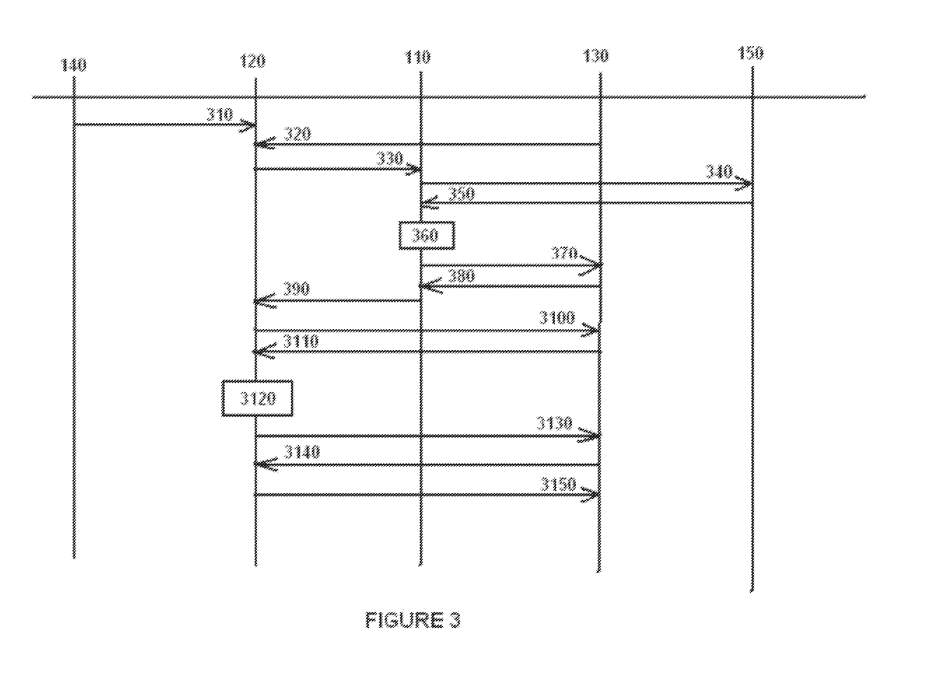

FIG. 3 is a signaling diagram illustrating signaling according to some example embodiments of the invention. The vertical axes represent user 140, storage system 120, reputation center 110, requesting user 130 and reputation source 150, respectively.

In phase 310, user 140 provides access criteria relating to the user's data to storage system 120. Alternatively, the access criteria may be provided to reputation center 110. In phase 320, requesting user 130 requests to obtain the data from storage system 120. In phase 330, storage system 120 requests reputation center 110 to determine, if requesting user 130 is to be granted access to the requested data, optionally also to which extent. In embodiments where storage system 120 was provided the access criteria in phase 310, storage system 120 may furnish the access criteria to reputation center 110 in phase 330. Storage system 120 may inform reputation center 110 of an identity of requesting user 130 in phase 330.

In phase 340, reputation center 110 may request reputation information of requesting user 130 from a reputation source 150, and responsively, in phase 350, receive it. Reputation center 110 may select reputation source 150 based at least in part on information comprised in the access criteria or the requests of phases 320 and 330. In phase 360 reputation center 110 is configured to compare the reputation information of requesting user 130, obtained from reputation source 150 or elsewhere, to the access criteria. Based at least in part on the comparison, reputation center 110 is configured to decide whether requesting user 130 is to be granted access to the data. Reputation center 110 may be configured to decide to grant only partial access to the data.

In optional phase 370, reputation center 110 may be configured to inform requesting user 130 of the decision to grant access, wherein the message of phase 370 may comprise information concerning a penalty to be applied to the requesting user 130 should he disclose the requested information to third parties, or otherwise abuse it. A penalty applied to the requesting user may comprise a penalty applied by decreasing the reputation of the requesting user. Where the message of phase 370 comprises information concerning a penalty, it may comprise a request for requesting user 130 to accept the penalty. In this case, in optional phase 380, requesting user 130 may acknowledge and accept the penalty, which may cause a legal agreement to enter into force between user 140 and requesting user 130. In some embodiments, should requesting user fail to acknowledge and accept the penalty, processing stops and access is not granted to requesting user 130. Under the legal agreement, the users agree that should requesting user 130 at least one of abuse and disclose the data, the penalty is to be applied. In connection with the legal agreement, a tracking mechanism may be implemented. A tracking mechanism may comprise a watermarking process as described above. Alternatively, a tracking mechanism may comprise maintaining a record, for example in storage system 120 or in reputation center 110, of users who have been granted access to the data. If the data is disclosed in breach of the legal agreement and only one user has been granted access to it, it may be concluded that the sole user to have been granted access is the one responsible for the disclosure.

In phase 390, reputation center 110 may be configured to indicate to storage system 120 that access is to be granted to the requesting user to the requested data. The indicating may comprise an indication as to an extent of access to be granted, as discussed above. The indication may comprise an indication that a penalty has been agreed. In optional phase 3100, storage system 120 may be configured to request an encryption key from requesting user 130, and requesting user 130 may be configured to responsively provide the requested encryption key in optional phase 3110. In phase 3120, storage system 120 may be configured to re-encrypt a data encryption key for requesting user 130. In some embodiments, storage system 120 is configured to, in phase 3120, re-encrypt a secret key to enable a requesting user to gain access to the data. In some embodiments, where the message of phase 390 comprises an indication that a penalty is agreed between the users, storage system 120 is configured to apply a digital watermark specific to requesting user 130, and optionally also a digital signature to the requested data before re-encrypting, to enable requesting user 130 to be identified as a responsible party in case the requested data is disclosed to third parties. In some embodiments the digital watermark and, optionally, the signature are applied every time, regardless of presence of an indication of a penalty in the message of phase 390. In some embodiments, storage system 120 is only configured to apply the digital watermark if storage system 120 is enabled to access an unencrypted version of the requested data. In some embodiments, storage system 120 cannot access an unencrypted version of the requested data. Storage system 120 may be configured to modify the requested data by requesting an encrypted digital fingerprinting from the data owner and aggregating the encrypted digital fingerprint and encrypted requested data together before providing the aggregated data to the requesting user. The encrypted fingerprint may be signed by the data owner to achieve non-repudiation.

In phase 3130, storage system 120 may be configured to inform requesting user 130 that the requested data is ready for retrieval. In phase 3140, requesting user may request for the requested data to be transmitted to him. In phase 3150, storage system 120 may be configured to transmit the requested data, to requesting user 130. In some embodiments storage system 120 is configured to transmit the requested data in phase 3130, and phases 3140 and 3150 don't exist.

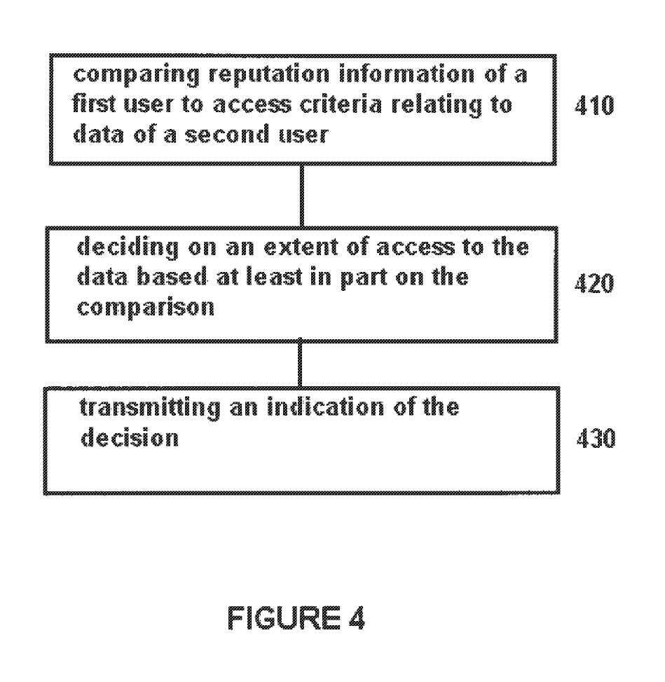

FIG. 4 is a flowchart illustrating a first method in accordance with at least some embodiments of the invention. The illustrated method may be performed in reputation center 110, for example. In phase 410, reputation information of a first user is compared to access criteria relating to data of a second user. The access criteria may be access criteria received in reputation center 110, for example, from the second user. The access criteria may relate to all data of the second user stored in an apparatus performing the method of FIG. 4, or it may be specific to a certain subset of the data, or an individual data file.

In phase 420, the method comprises deciding on an extent of access to the data based at least in part on the comparison of phase 410. An extent of access may comprise no access, partial access or full access, for example. In phase 430, an indication of the decision is transmitted, or caused to be transmitted. The indication may be transmitted, for example, to at least one of the first user and a storage service storing the data of the second user.

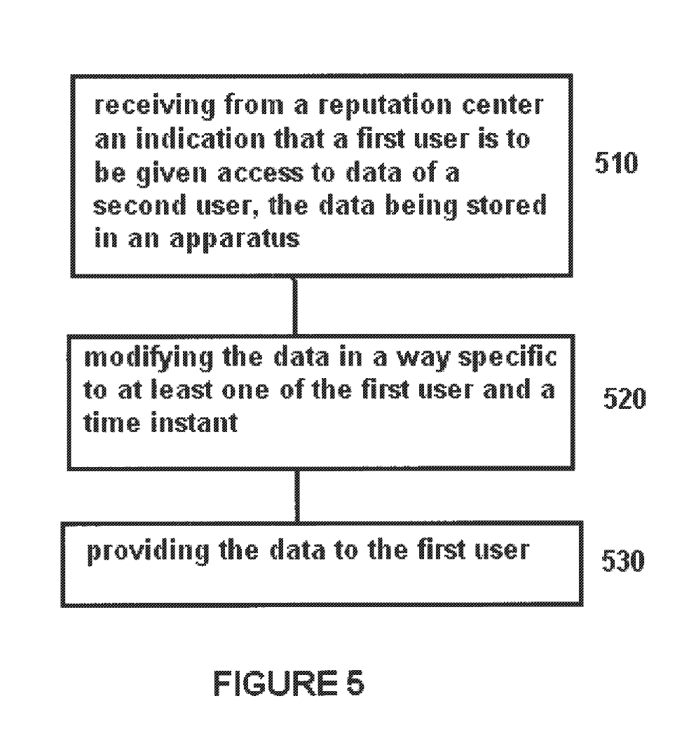

FIG. 5 is a flowchart illustrating a second method in accordance with at least some embodiments of the invention. The illustrated method may be performed in storage system 120, for example. In phase 510, the method comprises receiving from a reputation center an indication that a first user is to be given access to data of a second user, the data being stored in an apparatus. The apparatus may comprise storage system 120, for example. The indication may comprise at least one of an indication of extent of access to be granted to the first user, an identity of the first user, and an indication that a penalty has been agreed between the first and second users.

In phase 520, the method may comprise that the data is modified in a way specific to the first user. As discussed above, such a modification may comprise, for example, modifying the data using at least one of an identity of the first user and a timestamp. The modification may be essentially imperceptible in a media file, which may comprise that it is essentially not visible to the naked eye in an image file or that it is essentially inaudible to a natural person in an audio file. The modification may be referred to as a digital watermark. In some embodiments, in addition to the modification, the data is furnished with a digital signature to allow any further modification of the data to be detectable. Phase 520 is optional. In phase 530, the method may comprise providing the data to the first user. In some embodiments, the data is modified in a way specific to the first user only where storage system 120 is enabled to access an unencrypted version of the stored data. In some embodiments, storage system 120 is not enabled to access an unencrypted version of the stored data. Modifying the data in a way specific to the first user may comprise aggregating an encrypted digital fingerprint with the encrypted data. The digital fingerprint for aggregating may be requested from the data owner, for example responsive to a decision to grant access to the data to the first user. Such requesting may be done by storage system 120 responsive to storage system 120 being informed of the decision to grant access to the first user. Aggregating the encrypted digital fingerprint may comprise aggregating in accordance with homomorphic theory.

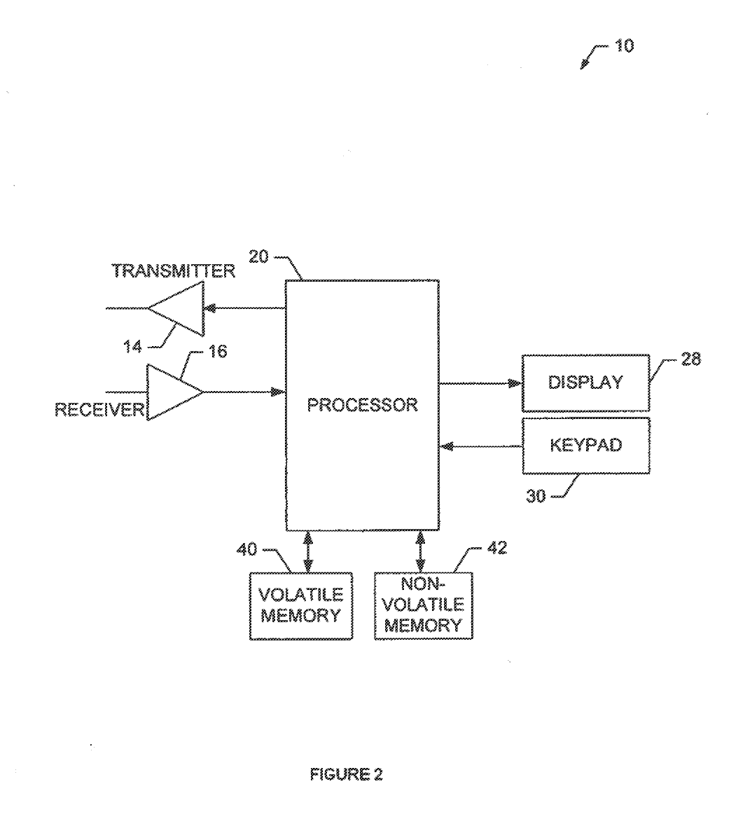

FIG. 2 illustrates a block diagram of an apparatus 10 such as, for example, a reputation center 110 or storage system 120, in accordance with at least one example embodiment of the invention. While several features of the apparatus are illustrated and will be hereinafter described for purposes of example, other types of electronic devices, such as mobile telephones, server computers, desktop computers, routers, gateways, and other types of electronic systems, may employ various embodiments of the invention.

As shown, the apparatus 10 may include at least one transmitter 14 and a receiver 16 configured to communicate information over a network, such as for example a wire-line or wireless communications network. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example an optional display or a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit, ASIC, or field programmable gate array, FPGA, or some combination thereof. Accordingly, although illustrated in FIG. 2 as a single processor, in some embodiments the processor 20 comprises a plurality of processors or processing cores.

It is understood that the processor 20 may comprise circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus may be allocated between these devices according to their respective capabilities. Further, the processor may comprise functionality to operate one or more software programs, which may be stored in memory. In general, processor 20 and stored software instructions may be configured to cause apparatus 10 to perform actions. For example, processor 20 may be capable of operating a program, such as a reputation center program. The program may allow the apparatus 10 to transmit and receive content, such as reputation information, according to a protocol, such as wireless application protocol, WAP, hypertext transfer protocol, HTTP, and/or the like

Apparatus 10 may also comprise a user interface including, for example, a display 28, a user input interface, and/or the like, which may be operationally coupled to the processor 20. In this regard, the processor 20 may comprise user interface circuitry configured to control at least some functions of one or more elements of the user interface. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. Although not shown, the apparatus may comprise a battery for powering various circuits related to the apparatus. The user input interface may comprise devices allowing the apparatus to receive data, such as a keypad 30.

The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, at least one data center, hard disks, at least one array of hard disks, floppy disk drives, magnetic tape, etc., optical disc drives and/or media, non-volatile random access memory, NVRAM, and/or the like. Like volatile memory 40 non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the apparatus.

Without in any way limiting the scope, interpretation, or application of the claims appearing below, a technical effect of one or more of the example embodiments disclosed herein is that control of access to data may be provided in a controlled, automated and trustworthy manner. Another technical effect of one or more of the example embodiments disclosed herein is that data security is improved. Another technical effect of one or more of the example embodiments disclosed herein is that management of reputation information in reputation sources may be improved.

Embodiments of the present invention may be implemented in software, hardware, application logic or a combination of software, hardware and application logic.

The software, application logic and/or hardware may reside on memory 40, the control apparatus 20 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
at least one processing core configured to compare reputation information of a first user to access criteria relating to data of a second user, the at least one processing core being configured to decide on an extent of access to the data based at least in part on the comparison, and
a transmitter configured to cause an indication of the decision to be transmitted to a storage service system, wherein the indication comprises an instruction to encrypt the data for the first user.

2. The apparatus according to claim 1, wherein the apparatus further comprises a receiver configured to receive an access request relating to the data, and wherein the at least one processing core is configured to decide on the extent of access to the data at least in part responsive to the access request.

3. The apparatus according to claim 1, wherein the apparatus is configured to receive the access criteria from the second user.

4. (canceled)

5. The apparatus according to , wherein the indication comprises an indication as to an extent of access.

6. The apparatus according to claim 1, wherein the indication comprises cryptographic information to enable the first user to access, at least in part, the data.

7. (canceled)

8. The apparatus according to claim 1, wherein the apparatus is configured to obtain the reputation information at least in part from the storage service system.

9. The apparatus according to claim 1, wherein the apparatus is configured to obtain the reputation information at least in part from a multi-user service.

10. The apparatus according to claim 9, wherein the reputation information comprises feedback information concerning the first user.

11. The apparatus according to claim 1, wherein the apparatus is configured to obtain the reputation information at least in part from at least one of an insurance company, a bank, a police database, a governmental database and a no-fly list.

12. The apparatus according to claim 1, wherein the apparatus is configured to obtain the reputation information from more than one source.

13. The apparatus according to claim 1, wherein the apparatus is configured to inform the first user of a penalty for unauthorized disclosure of the data.

14. A method, comprising:
comparing reputation information of a first user to access criteria relating to data of a second user;
deciding on an extent of access to the data based at least in part on the comparison, and
transmitting an indication of the decision to a storage service system, wherein the indication comprises an instruction to encrypt the data for the first user.

15. The method according to claim 14, further comprising receiving an access request relating to the data, and deciding on the extent of access to the data at least in part responsive to the access request.

16. The method according to claim 14, wherein the access criteria are received from the second user.

17. (canceled)

18. The method according to claim 14, wherein the indication comprises an indication as to an extent of access.

19. The method according to claim 14, wherein the indication comprises cryptographic information to enable the first user to access, at least in part, the data.

20. (canceled)

21. The method according to claim 17, further comprising obtaining the reputation information at least in part from the storage service system.

22. The method according to claim 14, further comprising obtaining the reputation information at least in part from a multi-user service.

23. The method according to claim 22, wherein the reputation information comprises feedback information concerning the first user.

24. The method according to claim 14, further comprising obtaining the reputation information at least in part from at least one of an insurance company, a bank, a police database, a governmental database and a no-fly list.

25. The method according to claim 14, wherein the method comprises obtaining the reputation information from more than one source.

26. The method according to claim 14, further comprising informing the first user of a penalty for unauthorized disclosure of the data.

27. An apparatus, comprising:
at least one processor;
at least one memory including computer program code, the at least one memory and the computer program code configured to, with the at least one processor, cause the apparatus to perform at least the following:
receive from a reputation center an indication that a first user is to be given access to data of a second user, the data being stored in the apparatus, and provide the data to the first user.

28. The apparatus according to claim 27, further comprising that the apparatus is caused to receive from the second user access criteria concerning data of the second user stored in the apparatus;

29. The apparatus according to claim 27, wherein the apparatus is caused to modify the data in a way specific to at least one of the first user and a time instant.

30. The apparatus according to claim 29, wherein the modifying comprises modifying based on at least one of a timestamp and an identity of the first user.

31. The apparatus according to claim 29, wherein the apparatus is configured to modify the data in a way specific to at least one of the first user and a time instant only in case the apparatus is enabled to access an unencrypted version of the data.

32. The apparatus according to claim 27, wherein the indication comprises an indication that a penalty has been agreed between the first and second users or between the reputation center and the first user.

33. The apparatus according to claim 32, wherein the apparatus is caused to perform the modifying responsive to the indication that a penalty has been agreed.

34. The apparatus according to claim 27, wherein the apparatus is not enabled to access an unencrypted version of the data and wherein the apparatus is configured to modify the data by aggregating the encrypted data and a digital fingerprint of the second user together before providing the first user access to the data.

35. (canceled)

36. (canceled)

37. (canceled)

38. (canceled)

39. (canceled)
